(19) United States
(12) Patent Application Publication
(10) Pub. No.: US 2019/0384861 A1
(43) Pub. Date: Dec. 19, 2019

(54) REAL-TIME GRAPH TRAVERSALS FOR NETWORK-BASED RECOMMENDATIONS

(71) Applicant: LinkedIn Corporation, Sunnyvale, CA (US)

(72) Inventors: Amol N. Ghoting, San Ramon, CA (US); Sumit Rangwala, Fremont, CA (US); Hema Raghavan, Mountain View, CA (US); Yao Chen, San Jose, CA (US)

(73) Assignee: LinkedIn Corporation, Sunnyvale, CA (US)

(21) Appl. No.: 16/010,312

(22) Filed: Jun. 15, 2018

(51) Int. Cl. G06F 17/30

(52) U.S. Cl. CPC G06F 17/30867; G06F 17/30958; G06N 99/005; G06F 17/30377; G06F 17/3053

(57) ABSTRACT

The disclosed embodiments provide a system for processing data. During operation, the system obtains a graph containing nodes, edges between the nodes, and attributes of the nodes and the edges. Next, the system stores an in-memory representation of the graph in a set of columns. The system then receives a request for performing one or more computations for traversing the graph, wherein the computation(s) include iterating through subsets of the nodes and additional subsets of the edges. To process the request, the system executes the computation(s) on the stored representation of the graph to generate a near-real-time ranking of candidates for recommending to a member of an online network. Finally, the system transmits, in a response to the request, at least a portion of the near-real-time ranking as connection recommendations in the online network.

### BACKGROUND

### Field

The disclosed embodiments relate to recommendation systems. More specifically, the disclosed embodiments relate to techniques for performing real-time graph traversals for network-based recommendations.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, recruiters may use the online professional network to search for candidates for job opportunities and/or open positions. At the same time, job seekers may use the online professional network to enhance their professional reputations, conduct job searches, reach out to connections for job opportunities, and apply to job listings.

Moreover, the dynamics of online networks may shift as connections among users evolve. For example, a user may add connections within an online network over time. Each new connection may increase the user's interaction with certain parts of the online network and/or decrease the user's interaction with other parts of the online network. Consequently, use of online networks may be improved by mechanisms for characterizing and/or modulating the dynamics among users in the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows the processing of a request using a graph in accordance with the disclosed embodiments.

FIG. 4 shows a flowchart illustrating the processing of data in accordance with the disclosed embodiments.

FIG. 5 shows a flowchart illustrating a process of generating a ranking of candidates for recommending to a member of an online network in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The disclosed embodiments provide a method, apparatus, and system for processing data. More specifically, the disclosed embodiments provide a method, apparatus, and system for performing real-time graph traversals for network-based recommendations. The network-based recommendations may include, but are not limited to, connection recommendations for members of an online network, job recommendations for job seekers in an online professional network and/or employment site, and/or other types of recommendations that can be generated from a graph that models entities and relationships among the entities.

To generate such recommendations in real-time, a graph that includes nodes, edges, and attributes of the nodes and edges may be loaded into memory on one or more computer systems. The in-memory representation of the graph may include a series of columns, with each column containing an identifier for a node or an edge and a number of attributes associated with the identifier. The in-memory representation may also be updated on a nearline basis based on events containing records of recent activity in the online network.

One or more computations for traversing the graph may be applied to the in-memory representation to generate a near-real-time ranking of candidates for recommending to a member of the online network. For example, a first set of computations may be applied to the in-memory representation of the graph to generate candidates for the member. A second set of computations may subsequently be applied to the in-memory representation to generate near-real-time features for the candidates. The features may then be inputted into a machine learning model to produce scores for the candidates, and the candidates may be ranked by the scores. Such computations may iterate through subsets of nodes and edges in the graph instead of utilizing conventional graph-querying techniques that generate query results by performing joins and filtering on nodes sand edges that match a set of query parameters.

Finally, some or all of the near-real-time ranking may be transmitted and/or used as connection recommendations in the online network. As a result, the disclosed embodiments may reduce latency and/or overhead associated with querying graph data from eventually consistent graph databases, processing graph queries using computationally expensive joins, generating features for candidates in an offline and/or batch-processing basis, and/or generating or ranking candidates based on older or stale graph data and/or features.

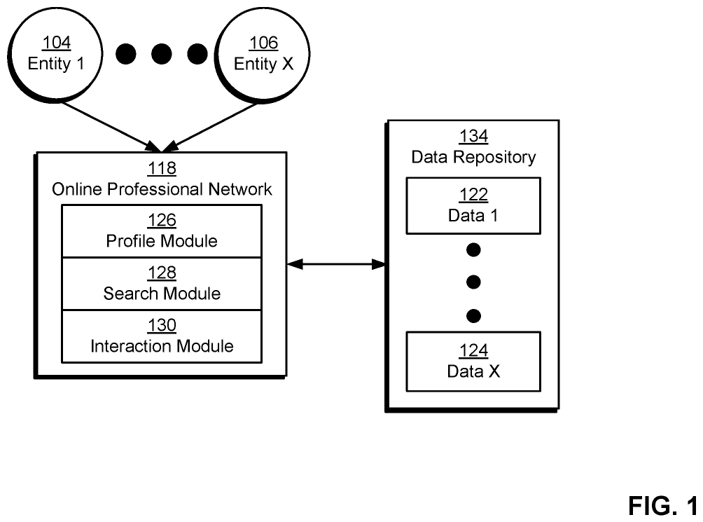

As shown in FIG. 1, network-based recommendations may be associated with a user community, such as an online professional network 118 that is used by a set of entities (e.g., entity 1 104, entity x 106) to interact with one another in a professional and/or business context. The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

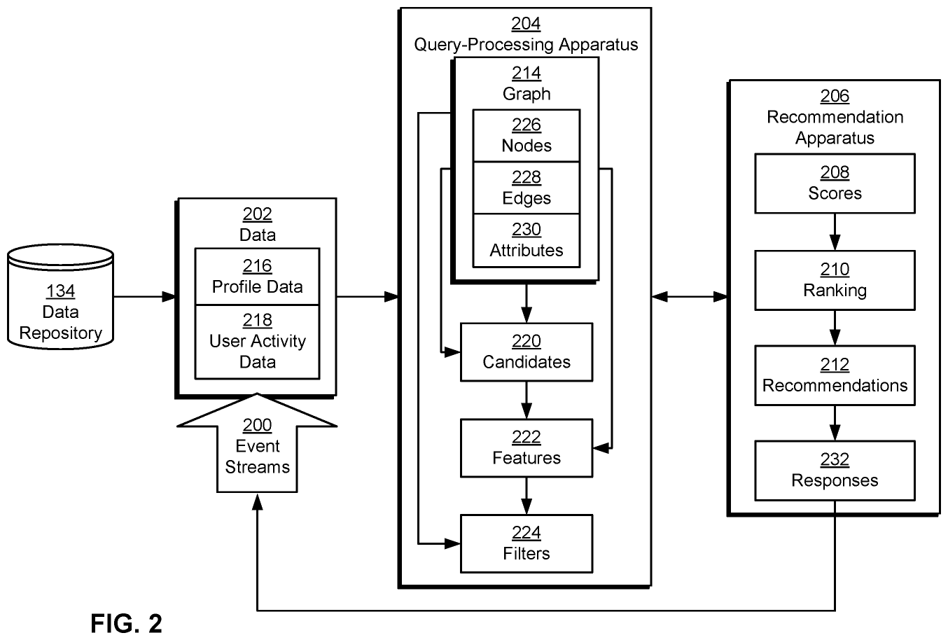

As shown in FIG. 2, data repository 134 and/or another primary data store may be queried for data 202 that includes profile data 216 for members of an online community (e.g., online professional network 118 of FIG. 1), as well as user activity data 218 that tracks the members' activity within and/or outside the online community. Profile data 216 includes data associated with member profiles in the online community. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online community.

Attributes of the members from profile data 216 may be matched to a number of member segments, with each member segment containing a group of members that share one or more common attributes. For example, member segments in the online community may be defined to include members with the same industry, title, location, and/or language.

User activity data 218 includes records of member interactions with one another and/or content associated with the online community. For example, user activity data 218 may track impressions, clicks, likes, dislikes, shares, hides, comments, posts, updates, conversions, and/or other user interaction with content in the online community. User activity data 218 may also track other types of activity, including connection invitations, new connections, messages, interaction with groups or events, job searches, job views, and/or job applications.

In one or more embodiments, profile data 216 and/or user activity data 218 are used to generate a set of candidates 220 for recommending to a member of an online network. For example, data 202 in data repository 134 may be used with a “People You May Know” product in an online professional network (e.g., online professional network 118 of FIG. 1) and/or another community of users. The product may identify, for a given member of the community, additional members as potential connections in the community based on features or attributes such as connections in common between the member and the additional members and/or overlap in employment or education between the member and additional members. The product may also display and/or otherwise output the potential connections as recommendations 212 to the member (e.g., in a user interface, email, message, notification, etc.). In turn, the member may send connection invitations to potential connections he/she recognizes, thereby increasing the member's connectivity within and/or engagement with the online community.

To facilitate generation of candidates 220 for recommending to members of the online community, profile data 216, user activity data 218, and/or other data 202 from the primary data store may be stored in a graph 214 of relationships and/or activity in the online community. For example, a representation of graph 214 may be stored in memory on one or more computer systems. The representation may be loaded and/or created from a snapshot of graph 214 in a distributed filesystem and/or other data store. The representation may also, or instead, be created from data 202 containing records of profile data 216 and/or user activity data 218 (e.g., from a relational database and/or other primary data store providing data repository 134).

A query-processing apparatus 204 may maintain and/or update graph 214 using data received over one or more event streams 200. For example, event streams 200 may be generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to data 202 and/or graph 214 from a source of truth for data 202 and/or graph 214. Query-processing apparatus 204 may receive events from event streams 200 and update graph 214 with updates to profile data 216 and/or user activity data 218 on a nearline basis (e.g., after the events are generated in response to member activity within or outside the online community). As a result, graph 214 may be more up to date with recent activity in the online community than an eventually consistent data store that is updated with profile data 216 and/or user activity data 218 over a period of minutes to hours.

Nodes 226 in graph 214 may represent entities in the online professional network. For example, the entities represented by nodes 226 may include individual members (e.g., users) of the online professional network, groups joined by the members, and/or organizations such as schools and companies. Nodes 226 may also represent other objects and/or data in the online professional network, such as industries, locations, posts, articles, multimedia, job listings, ads, and/or messages.

Edges 228 may represent relationships and/or interaction between pairs of nodes 226 in graph 214. For example, edges 228 may be directed and/or undirected edges that specify connections between pairs of members, education of members at schools, employment of members at organizations, business relationships and/or partnerships between organizations, and/or residence of members at locations. Edges 228 may also indicate actions taken by entities, such as creating or sharing articles or posts, sending messages, connection invitations, dismissal of connection invitations, joining groups, and/or following other entities.

Nodes 226 and edges 228 may also contain attributes 230 that describe the corresponding entities, objects, associations, and/or relationships in the online professional network. For example, a node representing a member may include attributes 230 such as a name, username, password, email address, location, company (e.g., an employer of the member), and/or school (e.g., an alma mater of the member). Similarly, an edge representing a connection between the member and another member may have attributes 230 such as a time at which the connection was made, the type of connection (e.g., friend, colleague, classmate, follow, etc.), a strength of the connection (e.g., how well the members know one another), and/or social validation associated with the connection (e.g., number of likes, number of shares, etc.).

Query-processing apparatus 204 uses the in-memory representation of graph 214 to generate, on a real-time or near-real-time basis, candidates 220 for recommending to members of the online community. For example, query-processing apparatus 204 may provide an application-programming interface (API) for performing computations on and/or traversals of graph 214. When a member logs in to the online community and/or interacts with a specific feature in the online community, query-processing apparatus 204 may receive a request and/or trigger to generate candidates 220 as connection recommendations 212 over the API. Alternatively, a component requesting candidates 220 and/or recommendations 212 may generate a series of calls to the API to produce data that can be used to identify candidates 220 and/or recommendations 212.

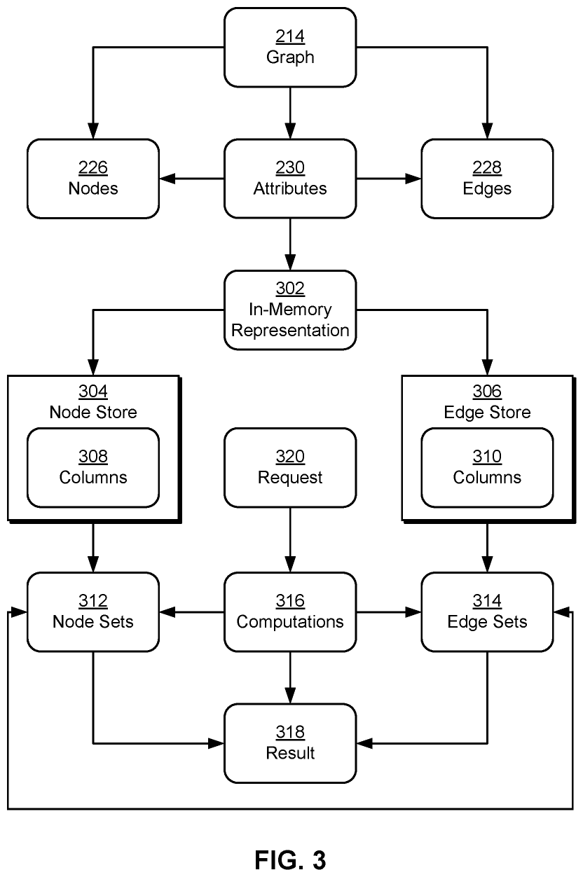

More specifically, query-processing apparatus 204 produces candidates 220 for recommending to the member by executing computations for traversing graph 214 on a real-time or on-demand basis. Continuing with the previous example, query-processing apparatus 204 may match one or more parameters of a request (e.g., a member identifier for a recently logged in or active member) to a subset of graph 214 (e.g., nodes 226 and/or edges 228 representing the member's connections in the online community). Query-processing apparatus 204 may then perform one or more computations on the identified subset of graph 214 to generate one or more additional subsets of graph 214 (e.g., nodes 226 and/or edges 228 representing connections of the member's connections and/or other members that overlap with the member in education or employment) that can be used to identify candidates 220 as potential connections of the member. Applying computations to subsets of graphs to generate query results is described in further detail below with respect to FIG. 3.

After candidates 220 are identified, query-processing apparatus 204 uses graph 214 to generate features 222 for candidates 220. For example, query-processing apparatus 204 may use computations and/or traversals of graph 214 to calculate features 222 such as a number of common connections between the member and a candidate, educational overlap between the member and candidate, employment overlap between the member and candidate, a triadic recency between the member and a candidate that is a second-degree connection (i.e., the recency of a triadic closure between the member and candidate), and/or the context in which the candidate was identified (e.g., a new connection of the member, a job view, a job application, a content feed interaction, etc.).

Query-processing apparatus 204 additionally uses graph 214 to apply one or more filters 224 to candidate connection recommendations 212 for a given member. For example, query-processing apparatus 204 may use nodes 226, edges 228, and/or attributes 230 of graph 214 to remove, from candidates 220, candidates that have sent a connection invitation to the member, received a connection invitation from the member, been dismissed as connection recommendations by the member, and/or dismissed the member as a connection recommendation.

A recommendation apparatus 206 uses features 222 for the filtered candidates 220 to calculate a set of scores 208 for candidates 220, generate a ranking 210 of candidates 220 by scores 208, and use ranking 210 to output recommendations 212 of some or all candidates 220 to the member. For example, recommendation apparatus 206 may apply weights, coefficients, parameters, and/or operations associated with a machine learning model to features 222 for each candidate to produce a score representing the likelihood that the member will connect with the candidate after the candidate is outputted as a connection recommendation to the member. Next, recommendation apparatus 206 may rank candidates 220 by descending score, so that candidates with the highest chance of connecting with the member are at the top of ranking 210 and candidates with a lower chance of connecting with the member are lower in ranking 210. Finally, recommendation apparatus 206 may display a list and/or other representation of ranking 210 to the member within the “People You May Know” feature or module of the online community. Recommendation apparatus 206 may also, or instead, transmit an email, notification, text message, and/or other communication containing one or more candidates in ranking 210 to the member.

Recommendation apparatus 206 and/or another component of the system may also, or instead, automatically apply changes to the member's connections and/or connection invitations based on scores 208 and/or ranking 210. For example, the component may automatically send connection invitations from the member to a highest-ranked subset of candidates in ranking 210 and/or a subset of candidates with scores 208 that exceed a threshold. In another example, the component may automatically add the member as a follower of the identified candidates. The component may optionally generate a notification, email, message, or other communication requesting that the member confirm his/her relationships with each candidate before performing the automatic change.

Recommendation apparatus 206 and/or another component of the system further tracks one or more responses 232 of the member to the outputted recommendations 212. For example, the member may have the option of accepting, rejecting (i.e., dismissing), or ignoring a connection recommendation. When the member accepts, rejects, or ignores a given recommendation, the component may emit an event containing the response of the member to the recommendation, identifiers for the member and the candidate in the recommendation, a timestamp of the response, and/or other data. In turn, the event may be received in one or more event streams 200 and subsequently used by query-processing apparatus 204 to update graph 214, identify additional candidates 220 for the member, and/or modulate ranking 210 or recommendations 212.

Recommendation apparatus 206 may also adjust scores 208 and/or ranking 210 based on the number of times the member has previously viewed a candidate (e.g., in previous sets of recommendations 212 to the member). For example, recommendation apparatus 206 may decrease a candidate's score and/or position in ranking 210 as the member's views of the candidate as a connection recommendation increase. In other words, the system of FIG. 2 may perform impression discounting of recommendations 212.

By generating candidates 220, features 222, filters 224, scores 208, ranking 210, and/or connection recommendations 212 from an in-memory graph 214 of nodes 226, edges 228, and attributes 230 that is updated on a near-real-time basis, the system of FIG. 2 may improve the timeliness, quantity, and/or quality of recommendations 212. Such recommendations 212 may increase the member's connectivity in the online community, engagement with the online community, the value of the member to the online community, and/or the value of the online community to the member. At the same time, the centralized, in-memory storage of graph 214 may allow candidates 220, features 222, filters 224, scores 208, ranking 210, and/or recommendations 212 to be generated in an on-demand basis (e.g., as a member interacts with the online community) instead of in an offline or periodic basis for all members of the online community. Consequently, the system may improve technologies related to use of online networks through network-enabled devices and/or applications, user engagement and interaction through the online networks, network-enabled devices, and/or applications, and querying or processing related to social network graphs and/or other types of graph-based data.

Those skilled in the art will appreciate that the system of FIG. 2 may be implemented in a variety of ways. First, query-processing apparatus 204, recommendation apparatus 206, and/or data repository 134 may be provided by a single physical machine, multiple computer systems, one or more virtual machines, a grid, one or more databases, one or more filesystems, and/or a cloud computing system. Query-processing apparatus 204 and recommendation apparatus 206 may additionally be implemented together and/or separately by one or more hardware and/or software components and/or layers.

Second, a number of machine learning models and/or techniques may be used to generate scores 208 and/or ranking 210. For example, scores 208 may be produced using a logistic regression model, Poisson regression model, artificial neural network, support vector machine, decision tree, naïve Bayes classifier, Bayesian network, clustering technique, hierarchical model, and/or ensemble model. Scores 208 may additionally represent and/or reflect various attributes, such as the likelihood of a connection between the member and each candidate, a change in activity level of the member and/or candidate in the community given the connection, and/or the value of the connection to each member and/or the community.

Third, graph 214 may be stored, formatted, and/or arranged in ways that facilitate efficient querying, updating, and/or scaling of nodes 226, edges 228, and/or attributes 230. For example, graph 214 may be partitioned across multiple computer systems as the size of graph 214 increases, with each partition storing nodes and/or edges of a specific type. Within each partition, sets of nodes 226 and/or edges 228 of a certain type or grouping (e.g., connections of a given member, employees of a company, students or alumni of a school, members in a certain location, etc.) may be stored in contiguous memory locations to improve traversals and/or computations related to the node and/or edge sets. To allow additional data to be written to each node and/or edge set, extra memory may be provisioned next to existing nodes and/or edges in the set. Identifiers for nodes 226 and edges 228 may also be contiguous to reduce the memory overhead associated with storing the identifiers (e.g., storing one identifier with the number of nodes or edges in a series of contiguous identifiers in a given grouping of nodes 226 or edges 228 instead of all identifiers for all nodes 226 and edges 228 in graph 214).

FIG. 3 shows the processing of a request 320 using graph 214 in accordance with the disclosed embodiments. Request 320 may be triggered by member activity with an online network and/or other type of community. For example, request 320 may be generated when a member logs in to the community and/or accesses one or more features in the community. In turn, a result 318 of request 320 may be generated by performing one or more computations 316 for traversing graph 214 and including and/or aggregating node sets 312 and/or edge sets 314 associated with computations 316.

As mentioned above, graph 214 may include nodes 226, edges 228 between pairs of nodes 226, and attributes 230 associated with nodes 226 and edges 228. For example, nodes 226 in graph 214 may represent members, companies, schools, jobs, publications, awards, posts, articles, and/or other entities in the community. Edges 228 may represent relationships or interactions between the entities, such as friendships, familial relationships, work relationships, follows, mentorships, and/or other types of relationships between members; employment of members at companies; education of members at schools; connection invitations, views of connection invitations, acceptances of connection invitations, and/or dismissals of connection invitations; views, clicks, likes, posts, comments, shares, and/or other types of interaction with content; and/or views, clicks, searches, messages, and/or applications related to jobs. Attributes 230 of nodes 226 may thus include names, locations, industries, contact information, and/or other identifying information for members, companies, schools, jobs, publications, awards, posts, articles, and/or other entities; creation times of nodes 226; and/or node types of nodes 226. Attributes 230 of edges 228 may include edge types (e.g., connections, follows, employment, education, group membership, etc.) of edges 228, creation times of edges 228 (e.g., the time at which two members were connected), edge strengths, and/or social validation associated with edges 228 (e.g., number of likes, number of shares, etc.).

Nodes 226, edges 228, and attributes 230 are stored in an in-memory representation 302 of graph 214. As described above, in-memory representation 302 may include nodes 226 and/or edges 228 of a certain type or grouping (e.g., connections of a given member) in contiguous memory locations to improve traversals and/or computations of graph 214. Extra memory may be provisioned next to existing nodes and/or edges in the set to allow additional data to be written to each grouping of nodes and/or edges.

More specifically, in-memory representation 302 includes a node store 304 and an edge store 306. Columns 308-310 in node store 304 and edge store 306 may store identifiers and attributes 230 for the corresponding nodes 226 and edges 228 of graph 214, respectively. For example, node store 304 and edge store 306 may include a series of primitive arrays that store identifiers and attributes 230 for nodes 226 and edges 228. Each array may represent a row in node store 304 or edge store 306, with all elements in the array storing attributes 230 of a certain kind. Conversely, each column in node store 304 or edge store 306 may be composed of array elements with the same index from multiple arrays. Data stored in the array elements may include identifiers and/or attributes 230 for a corresponding node or edge in graph 214.

Continuing with the example, a given column of node store 304 may include one or more identifiers (e.g., numerically unique identifier and/or an index into arrays of node store 304) for an entity in the community, followed by attributes that are defined for the entity (e.g., a member's name, email address, title, industry, location, school, and/or company). A given column of edge store 306 may be identified by an index into a set of arrays of edge store 306 and include attributes such as a time at which the corresponding edge was created, a type of the edge (e.g., a type of relationship or interaction), and/or metrics associated with the edge (e.g., a number of likes, a number of shares, etc.). Consequently, in-memory representation 302 may support a “hybrid” graph 214 with nodes 226 and edges 228 of different types and/or different subsets of attributes 230.

To reduce the memory footprint of in-memory representation 302, columns 308-310 in node store 304 and/or edge store 306 may be sorted and/or compacted according to one or more attributes. For example, columns 308 representing members in node store 304 may first be sorted by company, then further sorted by location for each company value. In turn, node store 304 may be compacted by storing each unique company name with the number and/or range of rows containing that company name. Within the rows that have the same company name, each unique location may be stored with the number or range of rows containing that location.

An example representation of node store 304 may include the following:

| | | | | |
|---|---|---|---|---|
| member_id: | 321 | 295 | 1255 | 22 |
| company: | Acme | Acme | Acme | Acme |
| location: | NY | NY | NY | SF |

In the above example, node store 304 includes a first row storing member identifiers, a second row storing companies of the members, and a third row storing locations of the members. Because columns 308 are first sorted by company, and then by location within each company, the “company” and “location” rows may have contiguous elements that contain the same value (e.g., “Acme” and “NY”). As a result, the “company” row may be compressed by generating an index that contains the value of “Acme” and a range of elements (e.g., array indexes) in the row that contain that value. Similarly, the first three elements of the “location” row may be compressed by generating an index that contains the value of “NY” and a range of elements (e.g., array indexes) that specify both a location of “NY” and a company of “Acme.”

In another example, columns 310 representing connections between members in edge store 306 may be sorted by the time at which the connections were made. As a result, the row containing connection times may be compressed by storing a representation of the earliest connection time (e.g., the time at which the first connection was made within the community), followed by deltas between the earliest connection time and all subsequent connection times. The deltas may also, or instead, be calculated periodically (e.g., from every 100^{th} connection time) to reduce the size of the deltas as time progresses.

In-memory representation 302 may optionally include, in node store 304, edge store 306, and/or another store (e.g., an adjacency list store), an adjacency list storing a set of nodes 226 to which a node is connected. For example, the adjacency list may store, for a given source node, identifiers for a set of destination nodes 226 to which the source node is connected and/or identifiers for a set of edges 228 connecting the source node and destination nodes. The destination nodes may include all nodes connected to the source node, or the destination nodes may be limited to those connected by edges 228 of a certain type (e.g., connections, follows, employment, education, etc.). In turn, the adjacency list may support efficient traversals of graph 214 and/or computations 316 related to the traversals.

After a given request 320 is received, one or more computations 316 used to process request 320 are identified and/or performed. As mentioned above, computations 316 may be applied to node sets 312 from node store 304 and/or edge sets 314 from edge store 306 to generate result 318. In particular, parameters and/or identifiers in request 320 may be used to generate a node set, and a function may be applied to an edge set containing all outgoing edges 228 of the node set to produce an edge set. Another function may also, or instead, be applied to the node set to generate a different node set. Such functions may include, but are not limited to, functions for calculating triadic recency (i.e., the recency of a triadic closure between two nodes 226), destination nodes 226 for a set of outgoing edges 228, calculating a set of nodes 226 that are connected to two specific nodes (e.g., to determine connections in common between two members), selecting a random subset of nodes and/or edges in a node set and/or edge set, and/or calculating a personalized PageRank (PageRank™ is a registered trademark of Google Inc.) score that reflects the connectedness and/or relative importance of a node in graph 214. The functions may additionally include user-defined or custom functions for applying various operations to node sets 312 and/or edge sets 314 in graph 214. Consequently, computations 316 related to processing of request 320 may involve iteratively applying a series of functions to node sets 312 and edge sets 314 to generate additional node sets 312 and edge sets 314 and/or filter existing node sets 312 and edge sets 314 until result 318 is produced.

For example, request 318 may be used to generate a list or ranking of candidates as potential connection recommendations for a member of the community. To identify the candidates, an identifier for the member may be retrieved from a parameter of request 318, and a computation may be used to retrieve a node set representing connections of the member in the community (i.e., nodes to which the member's node is connected in graph 214). The same computation may be repeated for all nodes in the node set to generate a larger node set containing second-degree connections of the member in the community, which are added to the set of candidates for the member. The candidates may also, or instead, be identified using one or more computations that identify members that have overlapped with the member in employment, education, group membership, attendance at an event, and/or another attribute.

Next, a set of features may be calculated for each candidate, including one or more network-based features that are produced using additional computations 316 applied to node sets 312 and/or edge sets 314. Such computations 316 may be used to produce a triadic recency between each candidate and the member (i.e., the recency of a second-degree connection between the member and candidate), the number of common connections between the member and candidate, educational overlap between the member and candidate, employment overlap between the member and candidate, and/or a context in which the candidate was identified (e.g., a new connection of the member, a job view, a job application, a content feed interaction, etc.).

The candidates may also be filtered based on data produced by further computations 316 applied to node sets 312 and/or edge sets 314. For example, one or more computations 316 may be used to identify and remove, from the set of candidates, those candidates who have already established a connection with the member, sent connection invitations to the member, received connection invitations from the member, dismissed the member as a connection invitation, and/or been dismissed by the member as a connection invitation. In another example, one or more computations 316 may be used to group and/or filter the candidates by education, current employer, past employer, and/or other attributes 230.

A machine learning model may then be applied to features of the remaining candidates to generate scores that can be used to rank the candidates. For example, a set of weights, coefficients, parameters, and/or operations from a logistic regression model, gradient boosted tree, random forest, and/or other type of machine learning model may be applied to features for each candidate to produce a score representing the likelihood of a connection between the member and the candidate.

Finally, the candidates may be ranked by score, and a subset of the candidates may be outputted as connection recommendations to the member. For example, the candidates may be ranked by descending score, so that candidates with the highest chance of connecting with the member are at the top of the ranking and candidates with a lower chance of connecting with the member are lower in the ranking. A list and/or other representation of the ranking may then be displayed or transmitted to the member within a “People You May Know” feature, an email, notification, text message, and/or other type of mechanism for interacting with the member.

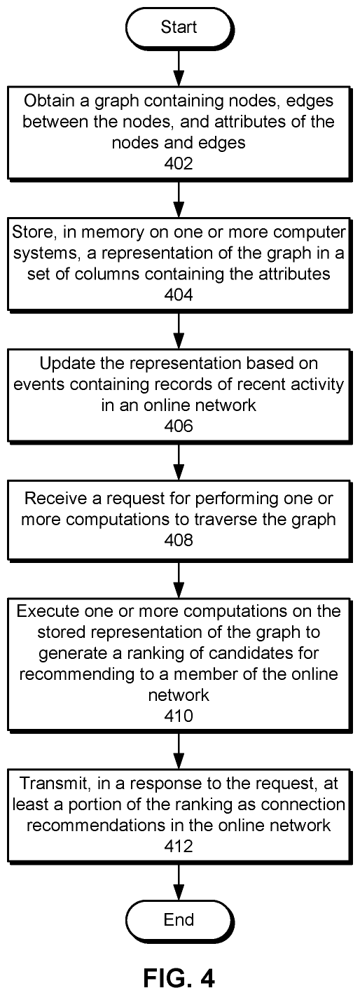

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a graph containing nodes, edges between the nodes, and attributes of the nodes and edges is obtained (operation 402). For example, a snapshot of the graph may be obtained from a distributed filesystem and/or other data store, or the graph may be created from records representing entities (e.g., users, jobs, companies, schools, content, groups, etc.), relationships (e.g., connections, follows, employment, education, group memberships, etc.), and/or activity (e.g., likes, shares, clicks, views, comments, posts, connection requests, etc.) in an online network.

Next, a representation of the graph is stored in a set of columns containing the attributes in memory on one or more computer systems (operation 404). For example, each row of the representation may be represented by a primitive array, with elements of the array storing a single type of attribute for a given node or edge. In turn, the node or edge may be represented by a column that is defined by the same array index in all rows or arrays of a given node store or edge store. The column may include an identifier for the node or edge and one or more attributes that have been defined for the node or edge.

The representation is also updated based on events containing records of recent activity in the online network (operation 406). For example, the events may be received over an event stream on a nearline basis and used to update the corresponding nodes, edges, and/or attributes of the representation.

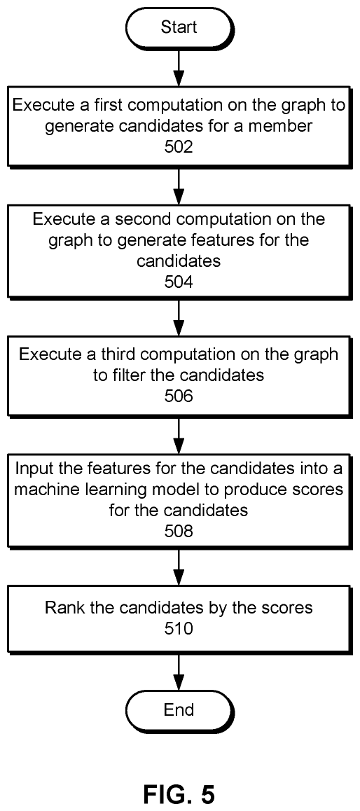

A request for performing one or more computations to traverse the graph is subsequently received (operation 408). For example, the request may be transmitted over an API in response to member activity in the online network. To process the request in real-time or near-real-time, one or more computations are executed on the stored representation of the graph to generate a ranking of candidates for recommending to a member of the online network (operation 410), as described in further detail below with respect to FIG. 5. The computations may include creating a node set from one or more identifiers in the request, applying a function to all outgoing edges of the node set and/or a random subset of the outgoing edges, and/or applying a different function to nodes in the node set. The functions may include, but are not limited to, a triadic recency function, a function for calculating destination nodes of the outgoing edges, and/or a function for calculating connections in common between a member and a candidate. The functions may thus be used to produce values related to attributes of the nodes and/or edges, apply filters to the nodes and/or edges, and/or aggregate the nodes and/or edges.

Finally, at least a portion of the ranking is transmitted in a response to the request as connection recommendations in the online network (operation 412). For example, a highest ranked subset of candidates may be transmitted in the response and subsequently displayed as connection recommendations to the member. Because the ranking is generated on-demand using a substantially up-to-date, in-memory representation of the graph, the ranking may include candidates that are identified on a real-time or near-real-time basis instead of candidates that are generated from older or stale data.

FIG. 5 shows a flowchart illustrating a process of generating a ranking of candidates for recommending to a member of an online network in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

The process begins with executing a first computation on a graph to generate candidates for the member (operation 502). For example, the first computation may identify, as candidates, members that are second-degree connections of the member, members who have overlapped with the member at a company or school, and/or members with other graph-based commonality to the member that are not yet connected to the member.

Next, a second computation is executed on the graph to generate features for the candidates (operation 504). For example, the second computation may be used to calculate a triadic recency, personalized PageRank, number of common connections, and/or other metric or attribute associated with each candidate and/or between the candidate and the member.

A third computation is then executed on the graph to filter the candidates (operation 506). For example, the third computation may be used to identify and remove, from the candidates, those candidates who have recently connected with the member, sent connection invitations to the member, received connection invitations from the member, dismissed the member as a connection recommendation, and/or been dismissed by the member as a connection recommendation. In other words, computations executed on the graph may iterate through multiple sets of nodes and edges in the graph to produce one or more results (e.g., candidates, features, filtered candidates, etc.).

The features for the candidates are then inputted into a machine learning model to produce scores for the candidates (operation 508). For example, the machine learning model may include coefficients, weights, parameters, and/or operations that are applied to features for each candidate to generate scores representing the likelihood of the member connecting with the candidate. Finally, the candidates are ranked by the scores (operation 510) for subsequent use as connection recommendations for the member, as discussed above.

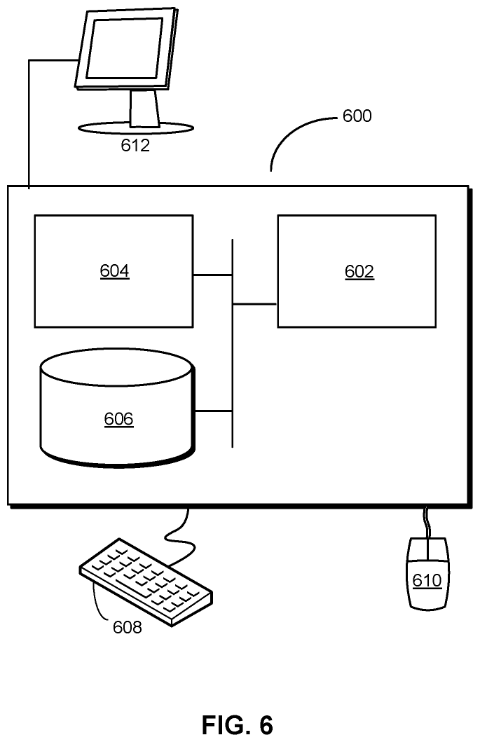

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system includes a query-processing apparatus and a recommendation apparatus, one or both of which may alternatively be termed or implemented as a module, mechanism, or other type of system component. The query-processing apparatus obtains a graph containing nodes, edges between the nodes, and attributes of the nodes and the edges. Next, the query-processing apparatus stores an in-memory representation of the graph in a set of columns, with each column containing an identifier for a node or an edge and a subset of the attributes associated with the identifier. The query-processing apparatus then receives a request for performing one or more computations for traversing the graph, which are performed by iterating through subsets of the nodes and additional subsets of the edges. To process the request, the query-processing apparatus executes the computation(s) on the stored representation of the graph to generate a ranking of candidates for recommending to a member of an online network. Finally, the recommendation apparatus transmits, in a response to the request, at least a portion of the ranking as connection recommendations in the online network.

In addition, one or more components of computer system 600 may be remotely located and connected to the other components over a network. Portions of the present embodiments (e.g., query-processing apparatus, recommendation apparatus, data repository, online professional network, etc.) may also be located on different nodes of a distributed system that implements the embodiments. For example, the present embodiments may be implemented using a cloud computing system that recommends potential connections to a set of remote members of an online network.

By configuring privacy controls or settings as they desire, members of a social network, online professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a graph comprising nodes, edges between the nodes, and attributes of the nodes and the edges;
storing, in memory on one or more computer systems, a representation of the graph in a set of columns, wherein each column in the set of columns comprises an identifier for a node or an edge and a subset of the attributes associated with the identifier;
receiving a request for performing one or more computations for traversing the graph, wherein the one or more computations comprise iterating through subsets of the nodes and additional subsets of the edges;
executing, by the one or more computer systems, the one or more computations on the stored representation of the graph to generate a near-real-time ranking of candidates for recommending to a member of an online network; and
transmitting, in a response to the request, at least a portion of the near-real-time ranking as connection recommendations in the online network.

2. The method of claim 1, further comprising:
updating the representation based on events comprising records of recent activity in the online network.

3. The method of claim 1, wherein executing the one or more computations comprises:
matching one or more parameters of the request to a first subset of the graph; and
executing the one or more computations on the first subset of the graph to generate a second subset of the graph.

4. The method of claim 1, wherein the one or more computations comprise:
creating a node set from node identifiers (IDs) in the request.

5. The method of claim 1, wherein the one or more computations comprise at least one of:
applying a first function to outgoing edges of a node set; and
applying a second function to nodes in the node set.

6. The method of claim 5, wherein the outgoing edges comprise at least one of:
all outgoing edges of the node set; and
a random subset of the outgoing edges.

7. The method of claim 5, wherein the first and second functions comprise:
a triadic recency function.

8. The method of claim 5, wherein the first and second functions comprise:
a function for calculating destination nodes of the outgoing edges.

9. The method of claim 5, wherein the first and second functions comprise:
a function for calculating connections in common between a member and a candidate.

10. The method of claim 1, wherein executing the one or more computations on the subsets of the nodes and the edges in the stored representation of the graph to generate the near-real-time ranking of candidates comprises:
executing a first computation on the graph to generate the candidates for the member;
executing a second computation on the graph to generate features for the candidates;
inputting the features for the candidates into a machine learning model to produce scores for the candidates; and
ranking the candidates by the scores.

11. The method of claim 10, wherein executing the one or more computations on the subsets of the nodes and the edges in the stored representation of the graph to generate the ranking of candidates further comprises:
executing a third computation on the graph to filter the candidates prior to inputting the features into the machine learning model.

12. The method of claim 1, wherein the attributes comprise:
a first attribute associated with one or more nodes in the graph; and
a second attribute associated with one or more other nodes in the graph.

13. The method of claim 1, wherein:
the representation of the graph is stored in a set of arrays in the memory; and
each array in the set of arrays stores a set of values for a single attribute in the graph.

14. A system, comprising:
one or more processors; and
memory storing instructions that, when executed by the one or more processors, cause the system to:
obtain a graph comprising nodes, edges between the nodes, and attributes of the nodes and the edges;
store, in the memory, a representation of the graph in a set of columns, wherein each column in the set of columns comprises an identifier for a node or an edge and a subset of the attributes associated with the identifier;
receive a request for performing one or more computations for traversing the graph, wherein the one or more computations comprise iterating through subsets of the nodes and additional subsets of the edges;
execute the one or more computations on the stored representation of the graph to generate a near-real-time ranking of candidates for recommending to a member of an online network; and
transmit, in a response to the request, at least a portion of the near-real-time ranking as connection recommendations in the online network.

15. The system of claim 14, wherein executing the one or more computations comprises:
matching one or more parameters of the request to a first subset of the graph; and
executing the one or more computations on the first subset of the graph to generate a second subset of the graph.

16. The system of claim 14, wherein the one or more computations comprise at least one of:
creating a node set from node identifiers (IDs) in the request;
applying a first function to outgoing edges of the node set; and
applying a second function to nodes in the node set or another node set.

17. The system of claim 16, wherein the first and second functions comprise at least one of:
a triadic recency function;
a function for calculating destination nodes of the outgoing edges; and
a function for calculating connections in common between a member and a candidate.

18. The system of claim 14, wherein executing the one or more computations on the subsets of the nodes and the edges in the stored representation of the graph to generate the near-real-time ranking of candidates comprises:
executing a first computation on the graph to generate the candidates for the member;
executing a second computation on the graph to generate features for the candidates;
executing a third computation on the graph to filter the candidates;
inputting the features for the candidates into a machine learning model to produce scores for the candidates; and
ranking the candidates by the scores.

19. The system of claim 14, wherein:
the representation of the graph is stored in a set of arrays in the memory; and
each array in the set of arrays stores a set of values for a single attribute in the graph.

20. A non-transitory computer-readable storage medium storing instructions that when executed by a computer cause the computer to perform a method, the method comprising:
obtaining a graph comprising nodes, edges between the nodes, and attributes of the nodes and the edges;
storing, in memory on the computer system, a representation of the graph in a set of columns, wherein each column in the set of columns comprises an identifier for a node or an edge and a subset of the attributes associated with the identifier;
receiving a request for performing one or more computations for traversing the graph, wherein the one or more computations comprise iterating through subsets of the nodes and additional subsets of the edges;
executing the one or more computations on the stored representation of the graph to generate a near-real-time ranking of candidates for recommending to a member of an online network; and
transmitting, in a response to the request, at least a portion of the near-real-time ranking as connection recommendations in the online network.
